(19) United States
(12) Patent Application Publication
(10) Pub. No.: US 2006/0047666 A1
(43) Pub. Date: Mar. 2, 2006

(54) Control of publish/subscribe messaging

(76) Inventors: Bharat Veer Bedi, Southsea (GB); Marc Stanley Carter, Southampton (GB); Andrew James Stanford-Clark, Southdown Lane Chale (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/209,445

(22) Filed: Aug. 23, 2005

(30) Foreign Application Priority Data
Aug. 28, 2004 (GB) 0419231.6

(51) Int. Cl. G06F 17/30

(52) U.S. Cl. 707/10

(57) ABSTRACT

Subscribers connected to a publish/subscribe message broker receive messages on topic names to which they have subscribed. The messages are published with respective topic names within a sequence of topic names. The subscribers initially subscribe to at least one topic in the sequence, and then await receipt of a published message on the subscribed topic. On receipt of a published message, the subscriber unsubscribes from the subscribed topic and subscribes to a previously-unsubscribed next topic in the sequence.

### BACKGROUND OF THE INVENTION

The present invention relates to controlling delivery of data messages in a publish/subscribe messaging environment.

The use of multicasting has increased dramatically over recent years, due to the evolving usage of intranets and other network systems. Multicasting is a useful technology for distributing the same data concurrently to a large number of users. In multicasting, a single network put is used to transmit the data messages to interested users that are connected to the network.

Typically, Internet Protocol (IP) multicasting transmits an IP data message to a host group (also known as a multicast group), which consists of zero or more hosts identified by a single IP destination address. This data message is delivered to all members of its destination host group. The membership of a host group is dynamic; that is members may join and leave groups at any time, and there is no restriction on the location or number of members in a host group. Also, a host may be a member of more than one group at a time, and a host need not be a member of a group to send data messages to it. The data message may comprise any type of information such as text messages, software patches, audio-visual media, virus updates etc.

This multicasting technology is indiscreet about who receives messages. This can be addressed by using a multicast group to restrict transmission and associating publish/subscribe concepts like topic names with multicast groups. As a result, a multicast message is only delivered to a user that subscribes to its topic (logically behind which is a multicast group).

Conventional publisher-subscriber models used fixed, pre-named topics to decouple the publishers and subscribers (for example “stock\IBM”). In these publisher-subscriber models, the publishers and subscribers are unaware of each other's existence, and each has a connection to a central broker. In a multicast environment that requires re-transmission of messages to a few subscribers, there are great inefficiencies because of the many subscribers who do not need re-transmission but are still subscribed to the same topic (and underlying multicast group) for further publications.

A typical example of such a system delivers anti-virus update files or software patches efficiently within large organizations using multicast. If all the computers were subscribed to a topic “updates” then most will get the message first time, but other machines will be offline at that time or fail to fully receive the message. This necessitates re-transmission of the message on the same topic (since the subscribers may not even know they missed anything). Clearly all the up-to-date subscribers (still listening for further updates) will be needlessly spammed this message many times. Even if the multicast system keeps the re-transmission frequency in check, the message still must be re-transmitted to the same multicast group, so that subscribers who have not previously received the message may receive the message.

### BRIEF SUMMARY OF THE INVENTION

According to one aspect of the present invention, a method for controlling receipt by a subscriber of messages having a respective topic name in a publish/subscribe messaging network comprises subscribing to at least one topic name within a sequence of topic names, receiving a published message having a first topic name to which the subscriber is subscribed, and unsubscribing from the first topic name in response to receiving the published message.

According to another aspect of the present invention, a method for controlling delivery of published messages to subscribers by a publish/subscribe message broker, wherein the message broker maintains subscription information identifying subscribers to respective message topics comprises receiving a published message from a publisher, transmitting the published message to at least one subscriber, wherein the transmitted message has a first topic name within a sequence of topic names and is transmitted to subscribers that are subscribed to receive messages having the first topic name, receiving an unsubscribe request from the first subscriber which unsubscribe request specifies the first topic name subsequent to transmitting a received message having the first topic name to a first subscriber, and updating the subscription information maintained at the message broker such that the first subscriber is no longer subscribed to receive messages having the first topic name in response to receiving the unsubscribe request.

According to a yet another aspect of the present invention, a method for controlling republication of messages by a publisher in a publish/subscribe messaging network comprises assigning sequential topic names to a sequence of messages and publishing the messages with their respective assigned topic name, checking whether any subscribers are active for assigned topic names, and republishing messages having topic names for which said checking determines that at least one subscriber is active, without republishing messages having topic names for which no subscribers are active.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a schematic representation of a multicast transmission system in accordance with one aspect of the present invention;

FIG. 2 shows an example hierarchical structure of topic updates maintained by the multicast transmission system of FIG. 1;

FIGS. 3A, 3B, and 3C shows schematic representations of exemplary message flows of the multicast transmission system of FIG. 1 at a series of times;

FIG. 4 shows a flow chart of a method of publishing data messages in accordance with one aspect of the present invention;

FIG. 5 shows a flow chart of a method of brokering multicast transmissions of published data messages in accordance with one aspect of the present invention;

FIG. 6 shows a flow chart of a method of controlling the flow of published data messages in accordance with one aspect of the present invention;

FIG. 7 shows a flow chart of a method of receiving subscribed data messages in accordance with one aspect of the present invention;

FIG. 8 is a schematic representation of a computer system suitable for performing the techniques described herein.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-usable or computer-readable would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

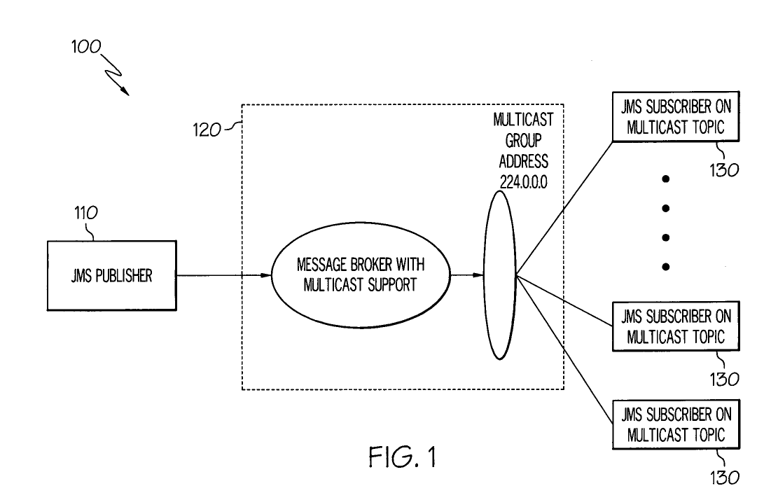

Turning now to FIG. 1, there is shown a schematic representation of a multicast transmission system 100 in accordance with one aspect of the present invention. For ease of explanation, the system 100 is described with reference to an IP multicasting transmission system, however the system 100 is not intended to be limited to such an environment. For example, the present invention can also be implemented in an unicast messaging system. The invention is also applicable to a publish/subscribe system in which subscriber applications filter publications to select the subset of published messages that the subscriber applications are subscribed to—without an intermediate broker. The present invention may also be used in intranets and in other network environments.

This multicast transmission system 100 comprises a publisher software application 110 for transmitting data messages via a central message broker software application 120 to a plurality of subscriber software applications 130. For ease of explanation, the system 100 of FIG. 1 shows only one publisher 110, however the system 100 has the capability of including a plurality of publishers 110 all capable of transmitting to subscribers 130 via the message broker 120. Typically, the publisher(s) 110, central message broker 120, and subscriber(s) 130 software applications all operate on different computers and communicate with each other via the Internet,

The system 100 of the present embodiment is based on a publish-subscribe model in which publishers transmit messages together with topic names (either within a message header or within the message content) and subscribers specify the topics that are of interest to them. In conventional publish/subscribe messaging, fixed and pre-named topics are used to decouple the publishers and subscribers, so that the publishers and subscribers are unaware of each other's existence. In this model, the subscriber software applications 130 are able to receive data messages on a particular topic from the message broker application 120 by first sending a message to the message broker software application 120 subscribing to that particular topic. On the other side, the publisher software application 110 can send data messages to the message broker software application 120 and specify a particular topic to enable publication to those subscribers 130 who have registered an interest in that particular topic. Furthermore, the subscriber software applications 130 can terminate their subscription to data messages on a topic at any time by sending an unsubscription message for that topic to the message broker application 120. In this model, the message broker software application 120 maps a data message on a particular topic to a corresponding multicast group designated by a single IP destination address and sends the data message to the subscribers within the multicast group.

The publisher software applications 110 and subscriber software applications 130 use a Java Message Service (JMS) interface for communicating with the message broker software application 120. The message broker software application 120 can be implemented using the WebSphere™ Business Integration Message Broker or Event Broker products sold by IBM™. Both these products support the multicast protocol and provide a Java Message Service (JMS) API for the multicast publishers 110 and subscribers 130 to implement. This API hides the complexities that can be associated with multicasting networking. For example, the Event Broker software application can automatically associate a multicast group address with a JMS topic. As a result, all that a JMS subscriber has to do in order to receive messages on a certain multicast group address is to subscribe to a multicast enabled topic (without having to know the multicast group address that is associated with the topic). Another known broker having similar capabilities to the aforementioned IBM™ products can be used as the message broker software application 120.

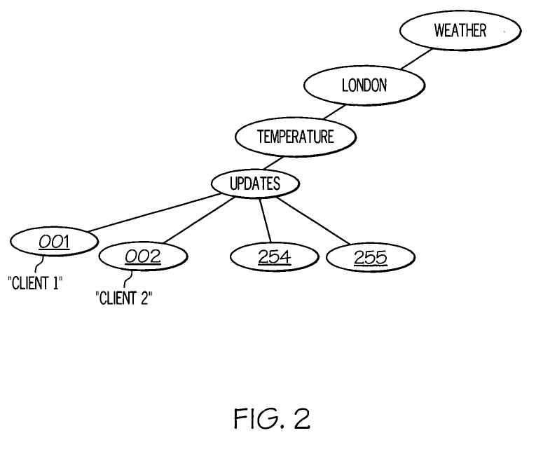

The message broker software application 120 conceptually maintains a hierarchical structure of topics into which publisher software applications 110 can publish messages, and the subscriber software applications 130 can subscribe to explicit topics and sub-trees of the hierarchy. This hierarchical structure of topics is in the form of a tree structure comprising nodes and leaf nodes, where each node of the structure corresponds to a particular topic into which data messages can be published. This tree structure also contains a list of subscribers for each topic. FIG. 2 shows an example of a topic tree branch within such an hierarchical structure of topics. As can be seen, the topic $weather/London/temperature/updates/001 comprises a list of subscribers to topic “ . . . /updates/001” which in this case has only one subscriber “client 1”, and a list of subscribers to “ . . . /updates/002” which in this case has only one subscriber “client 2”.

When a publication is received by the message broker software application 120, a matching engine of the broker undertakes a “section-by-section” match. That is the engine searches for those the parts of the topic delimited by “/” down the tree structure, until a node is reached that contains a list of all subscribers who have subscribed to receive that particular publication. The message broker software application 120 uses this subscriber information to send the publication to the appropriate subscribers.

The system 100 has the capability of efficiently handling updates that are published using named topics. For example, the system is able to handle efficiently antivirus update files or software patches within large organizations using multicast. The system 100 is able to use a taxonomy of incremental topic names. That is, the message broker software application maintains a topic hierarchy which is predefined to include incremental topic names such as for example $/software/updates/n, where n ranges from 0 to 255 (see also FIG. 2).

The hierarchical topic name structure may contain the name “updates” or some other ID to identify these topics as updates and distinguish them from other non-update topics. This enables selective application of the sequentially-updated topic names to just those topics for which control over delivery of republished messages is required.

From the point of view of the subscriber, the subscriber software application 130 begins by subscribing to such a topic update “ . . . /updates/n”. When the subscriber software application receives a multicast message on “ . . . /updates/n”, it unsubscribes from topic “ . . . /updates/n”, and subscribes to “ . . . /updates/n+1”, ready to receive the next new publication. Unsubscribing from topic “ . . . /updates/n” ensures that the user no longer repeatedly receives messages re-transmitted on topic “ . . . /updates/n” but messages published on this topic are still delivered to users that are still subscribed to topic “ . . . /updates/n”. From the point of view of the publisher, the publisher software application 110 transmits any new message using the next incremental topic name “ . . . /updates/n+1”, while re-transmitting previous topic numbers as it see fits. The incrementing of published topic names can be achieved by means of a simple counter that increments for every new message added for publication. The re-transmission can be achieved by re-transmitting, at suitable frequencies, earlier messages for which the topic name remains active. In this fashion, the system is able to minimize wasted communication bandwidth by avoiding the re-transmission of publications to subscribers that do not require them.

In the traditional (“pure”) publish/subscribe messaging model, publishers and subscribers are unaware of each other's existence, and each only has a connection to a central broker. Consequently, a publisher will continue to produce (publish) messages, even if there are no subscribers to receive the messages. When this happens, the broker simply discards the messages, as no subscribers have expressed an interest in receiving them.

A mechanism may be utilized whereby the publisher 110 is made aware of the subscribers 130 that are actively subscribed to a particular topic. This would allow the publisher to know how many subscribers are active on a particular topic. Based on this information, the publisher software 110 can make decisions on the re-publication frequency and removal of old topics and great efficiencies can be gained. In one embodiment, this mechanism is implemented at an external application level (using an unmodified publish/subscribe message broker infrastructure), whereas in another embodiment the message broker software application 120 can be modified to incorporate such a mechanism.

This mechanism involves tracking subscription and un-subscription messages from subscribing clients. This mechanism involves the utilization of activity counters on the topics, which counters are maintained by either the external application (herein called the Flow Controller), or the message broker itself.

When the counter for a topic (e.g. “x”) goes from 0 to 1 (i.e. the first subscriber joins the topic), or from 1 to 0 (when the last subscriber leaves the topic), a message is published (by either the Flow Controller application or by the broker, depending on where the mechanism is implemented) to a special topic (e.g. “subscriptions/topics/x”) saying “start” or “stop”, respectively.

A publisher that wishes to know if it is worthwhile publishing to topic x can subscribe to “subscriptions/topics/x”, and monitor the “start” and “stop” notifications being published on that topic, and can suspend or resume sending messages accordingly. This mechanism brings the further advantage that messages are not sent needlessly to the broker, simply to be thrown away, avoiding the cost associated with sending that message from the publisher. This can be particularly beneficial for expensive and/or slow network links.

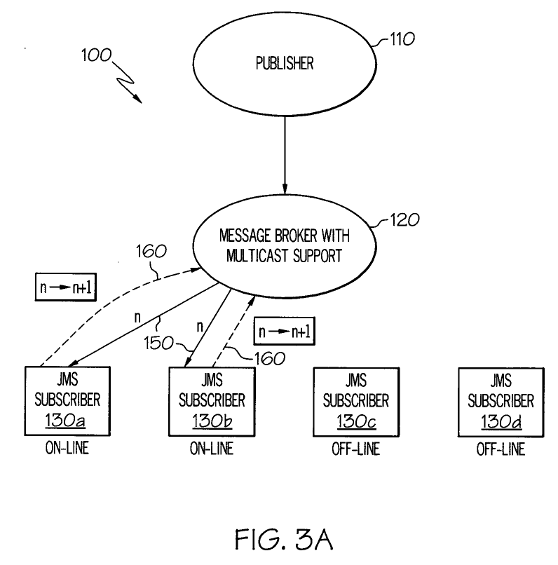

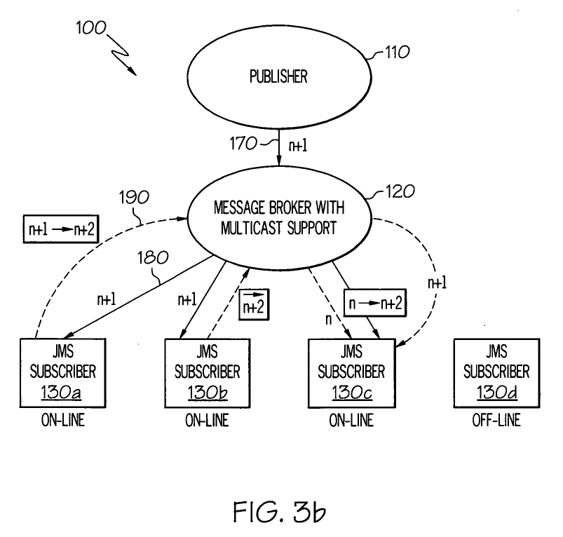

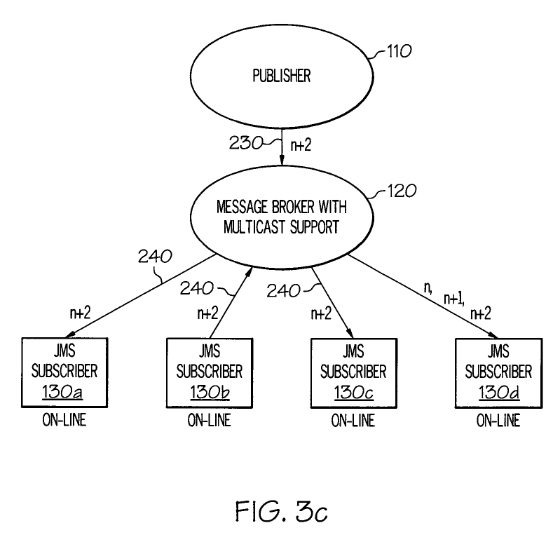

Turning now to FIGS. 3A, 3B, and 3C there are shown schematic representations of exemplary message flows of the multicast transmission system 100 at a series of times to more fully understand its operation.

During the time shown in FIG. 3A, there are four subscriber software applications 130A, 130B, 130C and 130D. Two applications 130A and 130B are online, and two applications 130C and 130D are off-line. These four subscriber software applications 130 are all registered with the message broker software application 120 as subscribers to the topic “n”. When the publisher software application 110 sends 140 a publication for publication on the topic “n”, the message broker software application 120 re-transmits 150 this publication to the registered subscribers 130. In response to receiving the publication on topic “n”, the two on-line subscribers 130A and 130B send an unsubscribe message for topic “n” and a subscribe message for topic “n+1” to the message broker software 120, which then updates its subscription lists.

During the time shown in FIG. 3B (subsequent to the time shown in FIG. 3A), there are four subscriber software applications 130A, B, C and D, three of which are online and one of which 130D is off-line. Two of these subscriber software applications are registered with the message broker as subscribers to topic “n+1”, whereas two others are registered as subscribers to topic “n”. When, the publisher software application 110 sends 170 a new publication for publication on the topic “n+1”, the message broker software application 120 transmits 180 this publication to the two subscribers 130A and B registered for topic “n+1”. In response to receiving the publication on topic “n+1”, the two on-line subscribers 130A and B send an unsubscribe message for topic “n+1” and a subscribe message for topic “n+2” to the message broker software 120, which then updates its subscription lists. In addition, the publisher software application 110 is aware that there are subscribers 130C and D active on topic “n” and so periodically re-transmits 200 the previous publication for topic “n”. In response to receiving the publication for topic “n”, the one online subscriber 130C that is registered for topic “n” sends 210 an unsubscribe message for topic “n” and a subscribe message for topic “n+1”. Subsequent to this, the publisher software application 110 becomes aware there exists an active subscriber on topic “n+1”. Consequently, the publisher 110 re-sends the publication on topic n+1 and the broker forwards the publication to subscriber 130C. On receipt, this subscriber 130C sends an unsubscribe message for topic “n+1” and subscribe message for topic “n+2” to the message broker software application 120, which then updates its subscription lists.

During the time shown in FIG. 3C (subsequent to the time shown in FIG. 3B), there are four subscriber software applications 130A, B, C and D—all of which are online. Three of these subscriber software applications are registered with the message broker as subscribers to topic “n+2”, whereas one is registered as a subscriber to topic “n”. When the publisher software application 110 sends 230 a new publication for publication on the topic “n+2”, the message broker software application 120 transmits 240 this publication to the three subscribers 130A, B, C registered for topic “n+2”. In response to receiving the publication on topic “n+2”, the three subscribers 130A, B, C send an unsubscribe message for topic “n+2” and a subscribe message for topic “n+3” to the message broker software 120, which then updates its subscription lists. In addition, the publisher software application 110 is aware that there are subscriber(s) 130D active on topic “n” and so periodically re-transmits the previous publication for topic “n”. In response to receiving the publication for topic “n”, the one on-line subscriber 130D that is registered for topic “n” sends an unsubscribe message for topic “n” and a subscribe message for topic “n+1”. Subsequent to this, the publisher software application 110 becomes aware there exists active subscriber(s) on topic “n+”. Consequently, the publisher 110 re-sends the publication on topic n+1, whereupon this subscriber sends an unsubscribe message for topic “n+1” and subscribe message for topic “n+2” to the message broker software application 120, which then updates its subscription lists. This procedure continues until this last subscriber subscribes to topic “n+3”.

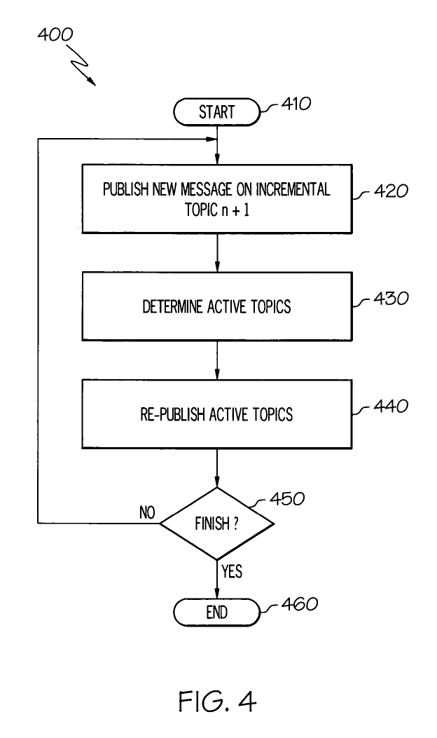

Turning now to FIG. 4, there is shown a flow chart of a method of publishing data messages in accordance with one aspect of the present invention. This method 400 is suitable for publishing data messages that comprise updates on a predefined topic such as for example anti-virus updates for anti-virus software or software patches for a software package. The steps of this method 400 may be implemented by software code in the form of a publisher software application such as described above. As would be appreciated by the man skilled in the art, the method 400 need not be limited to the control flow shown in FIG. 4. For instance, step 420 may be placed after step 440, steps 420, 430, 440 may run in separate modules concurrently; and many other arrangements are possible within the scope of the invention.

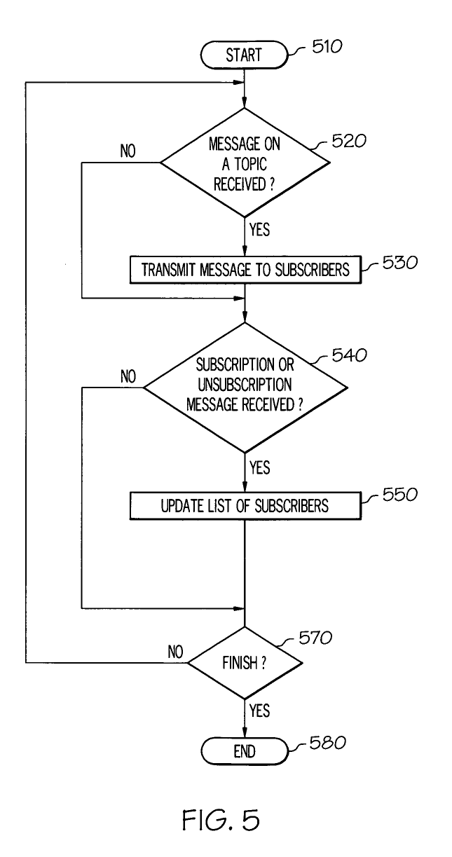

This method 400 may be used in conjunction with the methods described with reference to FIGS. 5 and 6, 7. The method 500 of FIG. 5 shows in general terms the operation of the known IBM® WebSphere® Business Integration Message Broker, which acts as a broker between the publishing method 400 and the subscriber method 700. IBM and WebSphere are trademarks of International Business Machines in the United States, foreign countries or both. However, the WebSphere Business Integration Message Broker utilizes a unique incremental topic hierarchy which in conjunction with the publishing method 400 and the subscribing method(s) 700 enables the efficient transmission of publication updates from the broker to the subscribers. The method 400 incorporates a further mechanism whereby the publisher is made aware of the subscribers that are actively subscribed to a particular topic (steps 430 and 440 in conjunction with steps 745 and 755 and method 600) for gaining still further efficiencies in transmission.

The method 400 commences 410 by initializing any necessary parameters. In particular, the method 400 retrieves information on topic names and associated data messages used in a previous session (if any) from file. For instance, the method may for example retrieve a topic update name such as “software/anti-virus/updates/12”. The method 400 also retrieves the status of topic counters used in previous sessions. These topic counters are associated with different “topics”, e.g. the topic tree “software/ant-virus/updates” has an associated topic counter virus-update. For ease of explanation, the method 400 is described below with reference to only one “topic” and its corresponding topic counter. This topic counter contains the number n of the topic, e.g. “software/anti-virus/updates/n”, on which the latest update was published.

The method 400 then proceeds to step 420, where it determines whether a user has input a new data message for publication as a further update. In the event that a new message has been input as a further update, the method 400 increments the appropriate topic counter from n to n+1 and publishes the new data message on topic “ . . . /updates/n+1”, e.g. “software/anti-virus/updates/n+1”. The method 400 publishes this latest data message by transmitting it to a message broker under the topic name “ . . . /updates/n+1”. During this step 420, the publisher also subscribes to a subscription topic relating to the published topic “n+1”, for example “subscriptions/software/antivirus/updates/n+1”, so that the publisher can be notified when subscribers begin and end their subscriptions to the topic “ . . . /updates/n+1”. After completion of step 420, or in the event no message has been input, the method proceeds to step 430.

The method 400 then determines 430 those topics that are still active, that is those topics to which subscribers are still subscribed. The method 400 finds this out by virtue of the publisher's subscription to the subscription topic(s) published by the flow control method 600.

The hierarchy and naming of such a subscription topic takes the form of “subscriptions/topic/n” so that messages published to this subscription topic indicate whether or not the topic topic/n is still active. Specifically, a message containing the text “start” published on a subscription topic “subscriptions/topic/n” indicates that a first subscriber has subscribed to the topic “topic/n”. Similarly, a message containing the text “stop” published on the subscription topic “subscriptions/topic/n” indicates that the last remaining subscriber has un-subscribed from the topic “topic/n” and there are no more subscribers to the topic.

The publisher receives the current activity status immediately it subscribes to a subscription topic through either a “start” or “stop” message on the subscription topic. This allows the publisher to know immediately if anyone is out there listening (subscribed) for the corresponding topic, e.g. “software/anti-virus/updates/n+1”. Afterwards, the publisher is kept informed through these “start” and “stop” messages on the activity of the topic. Upon receiving a “start” message on a subscription topic, the publisher will add the appropriate topic to a list of active topics, and similarly upon receiving a “stop” message on a subscription topic will remove the appropriate topic from the list. Through this process, the publisher maintains and determines 430 an updated list of active topics. After completion of this step 430, the method proceeds to step 440.

The publisher then re-publishes 440 the corresponding publications to these active topics determined during step 430. In this fashion, the publisher only re-publishes publications to the current active update topics, e.g. “software/anti-virus/updates/n” thus gaining large efficiencies by avoiding the re-publication of updates to subscribers that do not require them.

The method 400 may be in the form of an infinite loop allowing the method to continually update the active topics and periodically re-publish on the updated active topics. The method 400 further comprises a termination mechanism 450 enabling the method 400 to terminate 460 in response to user input.

In a further variation of the method 400, the subscription messages instead of containing the text “start” or “stop” contain the actual numbers of subscribers currently subscribing to the topic in question. The variant method 400 then uses this information to adjust individually the publication frequency of each active topic update.

Turning now to FIG. 5, there is shown a flow chart of a method of brokering multicast transmissions of published data messages in accordance with one aspect of the present invention. As mentioned earlier, this method 500 is used in conjunction with the methods described with reference to FIGS. 4 and 6, 7. The method 500 shows in simplified terms the operation of the known WebSphere Business Integration Message Broker, which acts a broker between the publishing method 400 and the subscriber method 700. However, it is important to recognize that in this embodiment, the WebSphere Business Integration Message Broker utilizes a unique incremental topic hierarchy which in conjunction with the publishing method 400 and the subscribing method(s) 700 enables the efficient transmission of publication updates from the publisher to the subscribers.

The method 500 may be in the form of an infinite loop with a termination mechanism 570 allowing termination of the method 500 in response to user input. The method 500 is continually on-line so that it can transmit and receive messages 24 hours a day. The method 500 comprises a sub-process 520 & 530 for enabling messages received from publishers to be re-transmitted to subscribers and a sub-process 540 & 550 for updating a list of current subscribers to the topics available. The sub-process 520& 530 determines 520 whether a message is received from a publisher, and if so transmits 530 this message in a multicast manner to the subscribers of this topic using information contained in a subscriber list, otherwise the method 500 proceeds with the infinite loop. The sub-process 540 & 550 determines whether a subscription or un-subscription message to a particular topic has been received from a subscriber, and if so updates the list of subscribers for that particular topic, otherwise the method 500 continues with the infinite loop. The message broker also has means (not shown) for a user to manually add new topics as required.

The broker maintains a unique topic hierarchy for topic updates that is previously agreed upon with the publisher. Specifically, the publisher informs the broker that it intends to publish updates on a particular topic, say for example ant-virus updates. The broker manually adds a new topic structure having a tree structure with leaf nodes 001 through to 255 corresponding to the incremental topic updates, e.g. “software/anti-virus/updates/n”. Initially, the list of subscribers contains no subscribers to the topic updates. However, once the publisher starts publishing updates using the incremental topic names (commencing with “ . . . /updates/001”) and subscribers subscribe to these incremental topic names, the method 500 then proceeds to transmit these updates to the subscribers thereby enabling the transmission of publication updates from the publisher to the subscribers.

The broker adds in addition to the incremental topic hierarchy, the following topics: subscription topics, a subscribe topic and an unsubscribe topic. The hierarchy and naming of such subscription topics takes the form of “subscriptions/topic/n” so the messages published to these subscription topics indicate whether or not the topics topic/n are still active. The publisher subscribes to these topics and from the information contained in these messages is then able to determine whether it is worthwhile to continue publishing those topics. The hierarchy and naming of the subscribe topic is of the form “subscriptions/subscribe”, whereas the unsubscribe topic is of the form “subscriptions/unsubscribe”. These topics are used by the subscriber method(s) 700 and the flow control method 600 in the generation of messages to subscription topics, e.g. “subscriptions/topic/n”, as described in more detail below.

In a further variation of the embodiment, the brokering method 500 dynamically allocates the incremental topic hierarchy and the subscription sub-tree hierarchy, in response to receipt of a first update publication from the publishing method. This variant avoids the manual generation of the hierarchies and speeds up the process of publication. To this end, it should be noted that WebSphere message broker programs allow the dynamic allocation of topic names and hierarchies.

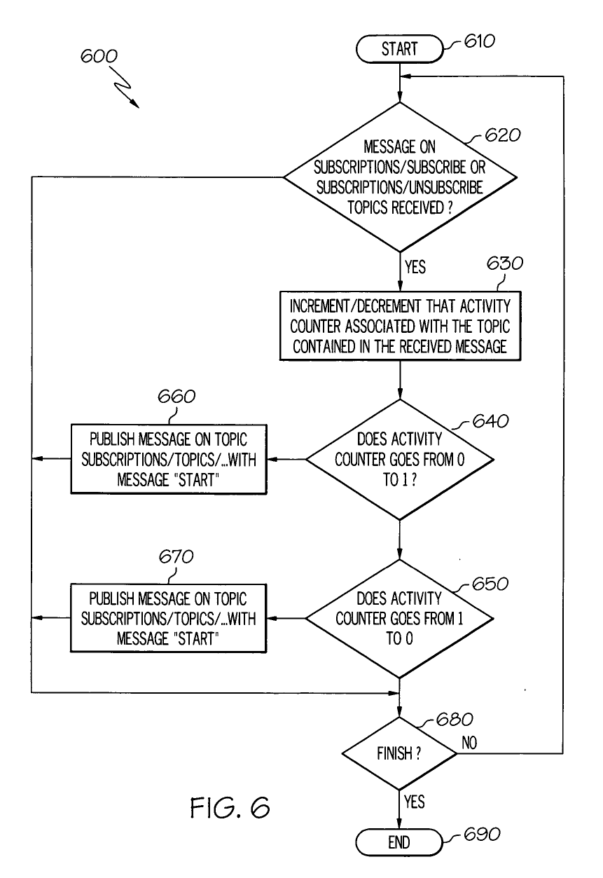

Turning now to FIG. 6, there is shown a flow chart of a method of controlling the flow of published data messages in accordance with one embodiment. As mentioned earlier, this method 600 is used in conjunction with the methods described with reference to FIGS. 4, 5, and 7. The steps of this method 600 are implemented by software code in the form of a software application. As would be appreciated by the man skilled in the art, the method 600 need not be limited to the control flow shown in FIG. 6, as many other arrangements are possible within the scope of the invention. The primary purpose of the flow control method 600 is to publish messages on the subscription topics “subscription/topics/n” containing the text “start” or the text “stop” thus indicating whether or not the topics topic/n are currently active.

The flow control method 600 is in the form of an infinite loop 620-680 with a termination mechanism 680 allowing termination 690 of the flow control method 600 in response to user input. The flow control method 600 is on-line at all times during the operation of the brokering method 500 and is terminated 690 when a user terminates the brokering method 500.

Once the flow control method 600 commences 610, the method 600 enters the infinite loop. During each pass of the infinite loop, the method 600 first determines 620 whether or not a message has just been received on either of the topics “subscriptions/subscribe” or “subscriptions/unsubscribe”. These messages are published by the subscribers when they subscribe to or unsubscribe from an incremental topic. The text of the message contains the name of the topic to which the subscribing method 700 is either subscribing to or unsubscribing from, such as “software/anti-virus/updates/n”. In the event the method 600 determines 620 that such a message has been received, the method 600 proceeds to increment/decrement 630 an associated activity counter. Specifically, the method 600 (i) increments an activity counter associated with the topic named in the text of the message published on “subscriptions/subscribe” and (ii) decrements the activity counter associated with the topic named in the text of the message published on “subscriptions/unsubscribe”. On the other hand, if the method 600 determines 620 no message is received, it returns via the terminating mechanism 680 to step 620 for the next pass of the loop.

After step 630, the method 600 then determines 640, 650 whether the activity counter was incremented from zero to one or from one to zero. In the case where the activity counter goes from zero to one, the method 600 publishes 660 a message on the topic “subscription/topics/n” with a text message “start”, which indicates that the topic “topic/n” is now active. In the case where the activity counter goes from one to zero, the method 600 publishes 670 a message on the topic “subscription/topics/n” with a text message “stop”, which indicates that the topic “topic/n” is not active. In any other case the method returns via the terminating mechanism 680 to step 620 for the next pass of the loop. After the publication 660, 670 of the messages, the method 600 also returns via the terminating mechanism 680 to step 620 for the next pass of the loop.

In this fashion, the flow control method 600 is able to inform the publishing method 400 (which subscribes to the topic “subscription/topics/n”) via the brokering method 500 when a topic is currently active. The published message should be a “retained” publication, so that the broker will automatically send the last-known value to a new client when they first subscribe to one of those topics. This will enable the current status of any topic to be obtainable from the broker.

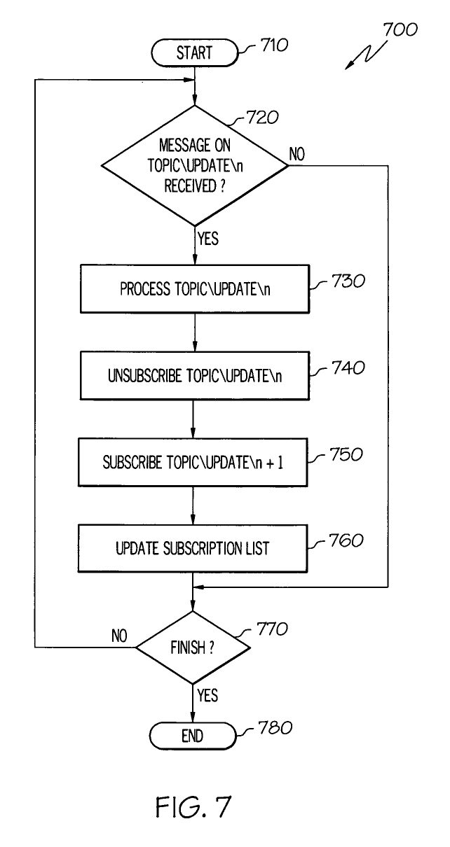

Turning now to FIG. 7, there is shown a flow chart of a method of receiving data messages in accordance with one aspect of the present invention. As mentioned earlier, this method 700 is used in conjunction with the methods described with reference to FIGS. 4, 5, and 6. The steps of this method 700 may be implemented by software code in the form of a subscriber software application such as described above. As would be appreciated by the man skilled in the art, the method 700 need not be limited to the control flow shown in FIG. 7, as many other arrangements are possible within the scope of the invention.

The method 700 of receiving data messages is preferably in the form of an infinite loop 720-770 with a termination mechanism 770 allowing termination 780 of the method 700 in response to user input. The method 700 also has the capability (not shown) for a user to initiate a subscription to a topic, such as topic updates, of his or her choosing.

The method 700 commences at step 710 during which it retrieves a list of topics to which a user has previously subscribed and then enters the infinite loop. During each pass of the infinite loop, the method 700 first determines 720 whether or not it has currently received a message on a subscribed topic (with reference to the list of subscribed topics). The method 700 is able to handle simultaneously a multitude of different types of topic updates, e.g. “software\patches\updates\ . . . ” and “antivirus\updates\ . . . . ” However for ease of explanation, the method 700 is described with reference to only one type of topic update, e.g. “topic\updates\ . . . ”. Furthermore, the method is able to distinguish and perform (not shown) in a normal fashion on all other non-update topics.

In the event the method 700 determines 720 that a message has been received on the subscribed topic “topic\updates\n”, it first processes 730 this message. For example, this processing may include loading and executing of software patches. After this processing step 730 has been completed, the method 700 then unsubscribes 740 from the “topic\updates\n” and subscribes 750 to “topic\update\n+1” ready for the next update. From this information, the brokering method 500 will subsequently send the subscriber the next update message n+1 and not resend it the previous update message n. The method 700 also publishes 740 a message to the topic “subscriptions/unsubscribe” containing the text “topic\updates\n” and publishes 750 a message to the topic “subscriptions/subscribe” containing the text “topic\updates\n+1”. The flow control method 600, uses this information together with similar information from all other subscribing methods 700 to inform the publishing method 400, whether a topic is still active or not. Finally, the method 700 updates its subscribed list of current topics by removing the topic “topic\updates\n” and adding the topic “topic\updates\n+1”. After which, the method 700 returns via the terminating mechanism 770 to step 720 to determine whether a message on the (next) topic “topic\updates\n+1” has been received.

In event the method 700 determines 720 that no message on “topic\updates\n” has been received, then the method 700 returns via the terminating mechanism 770 to step 720 to check again whether a message has been received on this topic “topic\updates\n”. The method continues in this fashion until a message on the topic “topic\updates\n” has been received.

Some publishing-subscriber protocols (for example, the IBM MQ Telemetry Transport), support a feature called “Last Will and Testament”, where a message will be sent on behalf of a subscriber which is unexpectedly disconnected. If such a mechanism is available, and non-durable subscriptions are being used (i.e. ones which are deleted from the broker when a subscriber disconnects), then a Last Will and Testament message should be set up which publishes a message to “subscriptions/unsubscribe” topic, containing a list of the topics to which the subscriber had subscribed. This ensures that the activity count for those topics is decremented when that subscriber disconnects. Note that for durable subscriptions that persist across subscriber sessions, this is not necessary.

A further variation of the system 100 implements a sliding window of topic updates, such as using topic names numbered from n to n+k. Specifically, the subscriber subscribes to a group of topic names, such as updates n through to n+k. When the subscriber completes the processing of a message update n, the subscriber unsubscribes from update n and subscribes to update n+k+1. Consequently, the subscriber will not necessarily lose the next message update n+1 if the subscriber is still processing a prior message update n. This overcomes a potential problem with untimely subscribers who may still be processing topic n (and are not yet subscribed to topic n+1) when the topic update n+1 is published. In the above-described system, the untimely users may have to wait for re-transmission of a topic n+1 if they are busy with messages on another topic n. Control on the size of this sliding topic name window and information on the “current” topics can be held in a further meta-topic. In one example, the size of the window can be set “infinitely” large such that subscribers subscribe to a group of topics >n and once the subscriber finishes processing of topic n+1, the subscriber subscribes to the group of topics >n+1. As to tardy subscribers who still cannot process fast enough, such subscribers may have to wait until re-transmission of the messages.

As to new subscribers to the system 100 who need to “catch up” with existing on-line subscribers, there are basically two scenarios to consider. The first scenario is where only the latest version is needed, e.g. a virus definitions update file. In this situation, the subscriber merely needs to subscribe to the latest update topic. The present system 100 is easily able to cater for such a scenario. However, in a second scenario each subscriber may need a complete inventory of all the updates, e.g. software patches. In this situation if a new subscriber comes along (or re-enters the system after a long period of disconnection in relation to the publish rate) the subscriber desires ‘everything’ that the subscriber has missed. The present system 100 can be modified such that the broker would view a new subscription on a topic as a request for republication of earlier messages. Alternatively, the present system 100 can be modified such that publisher/broker interface has a backward facing sliding window (in similar fashion to the forward facing window of the subscriber). In this case a new subscription would result in the republication of all messages within this window. Beyond the backward limit, re-publication would not occur and the application programmer would have to manually intervene. The size of this window would be stored in a meta topic and can be calculated based on time, message volume, etc.

The methods 400, 500, 600, and 700 utilize a further mechanism to increase efficiencies by re-publishing messages only to active topics (those topics which currently have subscribers). An aspect of this mechanism resides in the flow control method 600. In a further variation, the flow control method can be implemented inside the publish/subscribe broker. This is the more efficient of the two implementations, but requires modification to the publisher/subscribe broker, and places a pre-requisite on a particular model of implementation for the “matching engine” of the broker. Hence it is less general than the application-based implementation described earlier.

In this particular variation, a publisher registers its “interest” in a particular topic. This is an indication of which topics the publisher intends to publish on, and hence which topics the publisher would like to know when it is worthwhile to publish on. The publisher also subscribes to a special system topic in the broker, for example “$system/subscriptions/x/y/z” which indicates that the publisher would like to know if it is worthwhile publishing to topic “x/y/z”. When the publisher no longer wishes to know if it is worthwhile publishing to a topic, the publisher unsubscribes from the system topic (“$system/subscriptions/x/y/z”). When a publisher subscribes to this special system topic, a marker is placed at the appropriate place in the topic matching tree, to indicate interest from a publisher. Note this is not a conventional subscription entry as the publisher is not listed as a subscriber to normal messages on that topic. Instead, the marker is an indication of interest in subscription changes.

When a client subscribes or unsubscribes from topics, the broker modifies its subscription tree structure, and in doing so, looks out for annotated nodes in the path to where the tree is being modified (with a client being added or removed from the tree). For any annotated nodes that it finds, the broker sends out a publication on the appropriate notification topic, with either “start” or “stop” in the message body, depending on whether the first client was being added under that topic sub-tree, or whether the last client was being removed from under that topic sub-tree, respectively. The published message should be a “retained” publication, so that the broker will automatically send the last-known value to a new client when they first subscribe to one of those topics. This will enable the current status of any topic to be obtainable from the broker. In this way, the broker will notify interested parties (i.e. publishers) when it is worthwhile or not to publish to any given topic.

An alternative embodiment to the above-described solution comprises a broker and subscribers that implement the incrementing sequence of topic names whereas publishers do not use incrementing topic names. That is, publishers can continue to use conventional topic names and are not subscriber aware. The publishers can continue republishing messages in accordance with known techniques, but the broker and subscribers implement incrementing topic names to reduce repeated transmissions between the broker and subscribers and therefore to reduce network traffic and subscriber workloads. As well as avoiding the need for any change to conventional publishers, a ‘publisher-unaware’ implementation in which the broker and subscribers assign unique incremental topic names to messages may be advantageous in an environment in which multiple publishers can concurrently publish messages on the same topic—since there is no requirement for agreement between the publishers on the allocation of topic names in the sequence. In other embodiments, the issue of allocation of topic names between concurrent publishers may be handled simply by each publisher using a different topic (such as by combining a unique publisher identifier with incremental topic names).

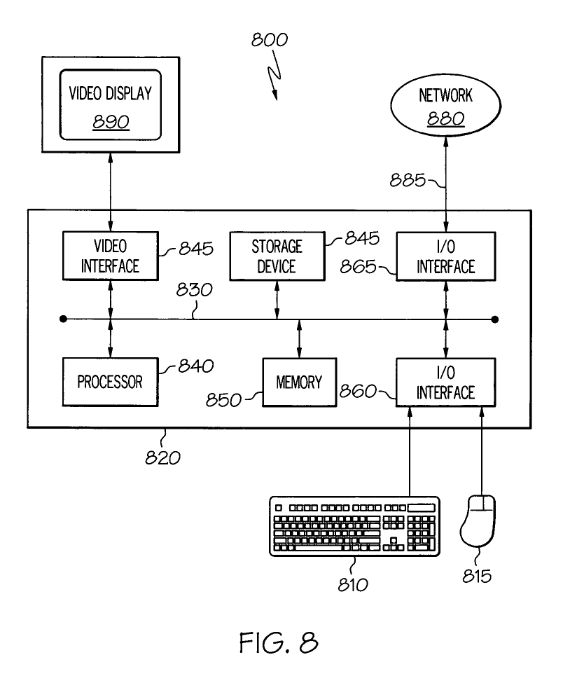

FIG. 8 is a schematic representation of a computer system 800 of a type that is suitable for executing computer software for implementing the steps of the methods shown and described with reference to FIGS. 4, 5, 6, and 7. Computer software executes under a suitable operating system installed on the computer system 800, and may be thought of as comprising various software code means for achieving the particular steps of the methods.

The components of the computer system 800 include a computer 820, a keyboard 810 and mouse 815, and a video display 890. The computer 820 includes a processor 840, a memory 850, input/output (I/O) interfaces 860, 865, a video interface 845, and a storage device 855. The processor 840 is a central processing unit (CPU) that executes the operating system and the computer software executing under the operating system. The memory 850 includes random access memory (RAM) and read-only memory (ROM), and is used under direction of the processor 840. The video interface 845 is connected to video display 890 and provides video signals for display on the video display 890. User input to operate the computer 820 is provided from the keyboard 810 and mouse 815. The storage device 855 can include a disk drive or any other suitable storage medium.

Each of the components of the computer 820 is connected to an internal bus 830 that includes data, address, and control buses, to allow components of the computer 820 to communicate with each other via the bus 830. The computer system 800 can be connected to one or more other similar computers via a input/output (I/O) interface 865 using a communication channel 885 to a network 880.

The computer software may be recorded on a portable storage medium, in which case, the computer software program is accessed by the computer system 800 from the storage device 855. Alternatively, the computer software can be accessed directly from the network 880 by the computer 820. In either case, a user can interact with the computer system 800 using the keyboard 810 and mouse 815 to operate the programmed computer software executing on the computer 820.

The flowchart and block diagrams of the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is apparent to one skilled in the art that numerous modifications and departures from the specific embodiments described herein may be made without departing from the spirit and scope of the invention.

What is claimed is:

1. A method for controlling receipt by a subscriber of messages having a respective topic name in a publish/subscribe messaging network, the method comprising:
subscribing to at least one topic name within a sequence of topic names;
receiving a published message having a first topic name to which the subscriber is subscribed; and
unsubscribing from the first topic name in response to receiving the published message.

2. The method of claim 1, wherein subscribing to at least one topic name within a sequence of topic names comprises subscribing to a group of topic names within the sequence of topic names.

3. The method of claim 2, further comprising:
processing a received message having a first topic name; and
receiving a message having a second topic name in the sequence of topic names concurrently with processing said received message.

4. The method of claim 1, further comprising:
subscribing to a previously-unsubscribed topic name comprising a next available topic name in the sequence of topic names.

5. The method of claim 1, further comprising communicating with a publish/subscribe message broker to request updates to subscription information stored by the broker for the respective subscriber.

6. A method for controlling delivery of published messages to subscribers by a publish/subscribe message broker, wherein the message broker maintains subscription information identifying subscribers to respective message topics, the method comprising:
receiving a published message from a publisher;
transmitting the published message to at least one subscriber, wherein the transmitted message has a first topic name within a sequence of topic names and is transmitted to subscribers that are subscribed to receive messages having the first topic name;
receiving an unsubscribe request from the first subscriber which unsubscribe request specifies the first topic name subsequent to transmitting a received message having the first topic name to a first subscriber; and
updating the subscription information maintained at the message broker such that the first subscriber is no longer subscribed to receive messages having the first topic name in response to receiving the unsubscribe request.

7. The method of claim 6, further comprising:
updating the subscription information maintained at the message broker to subscribe the first subscriber to a previously-unsubscribed topic name comprising a next available topic name in the sequence of topic names.

8. The method of claim 6, further comprising:
executing a process at the message broker to automatically generate a topic hierarchy comprising the sequence of topic names.

9. The method of claim 6, wherein the messages are published in a multicast manner.

10. The method of claim 6, further comprising:
publishing a message on a first predefined meta topic containing the name of the unsubscribed topic.

11. A method for controlling republication of messages by a publisher in a publish/subscribe messaging network, the method comprising:
assigning sequential topic names to a sequence of messages and publishing the messages with their respective assigned topic name;
checking whether any subscribers are active for assigned topic names; and
republishing messages having topic names for which said checking determines that at least one subscriber is active, without republishing messages having topic names for which no subscribers are active.

12. The method of claim 11, wherein checking whether any subscribers are active for assigned topic names comprises communicating to a message broker a desire for informati0on regarding subscription updates for one or more specified topic names.

13. A computer program product for controlling delivery of published messages to subscribers in a publish/subscribe messaging system, the computer program product comprising:
a computer usable medium having computer usable program code embodied therein, the computer usable program code comprising,
computer usable program code configured to subscribe to at least one topic name within a sequence of topic names;
computer usable program code configured to receive a published message having a first topic name to which the subscriber is subscribed; and
computer usable program code configured to unsubscribe from the first topic name in response to receiving the published message.

14. A computer program product for controlling delivery of published messages to subscribers in a publish/subscribe messaging system, the computer program product comprising:
a computer usable medium having computer usable program code embodied therein, the computer usable program code comprising,
computer usable program code configured to receive a published message from a publisher;
computer usable program code configured to transmit the published message to at least one subscriber, wherein the transmitted message has a first topic name within a sequence of topic names and is transmitted to subscribers that are subscribed to receive messages having the first topic name;
computer usable program code configured to receive an unsubscribe request from the first subscriber which unsubscribe request specifies the first topic name subsequent to transmitting a received message having the first topic name to a first subscriber; and
computer usable program code configured to update the subscription information maintained at the message broker such that the first subscriber is no longer subscribed to receive messages having the first topic name in response to receiving the unsubscribe request.

15. A computer program product for controlling republication of messages by a publisher in a publish/subscribe messaging system, the computer program product comprising:
a computer usable medium having computer usable program code embodied therein, the computer usable program code comprising,
computer usable program code configured to assign sequential topic names to a sequence of messages and publishing the messages with their respective assigned topic name;
computer usable program code configured to check whether any subscribers are active for assigned topic names; and
computer usable program code configured to republish messages having topic names for which said checking determines that at least one subscriber is active, without republishing messages having topic names for which no subscribers are active.

16. A data processing system for controlling delivery of published messages to subscribers according to a publish/subscribe messaging model, the system comprising:
a data processing unit;
a data storage unit; and
a subscriber program configured to subscribe to at least one topic name within a sequence of topic names; receive a published message having a first topic name to which the subscriber is subscribed; and unsubscribe from the first topic name in response to receiving the published message.

17. A data processing system for controlling delivery of published messages to subscribers according to a publish/subscribe messaging model, the system comprising:
a data processing unit;
a data storage unit; and
a message broker program configured to receive a published message from a publisher; transmit the published message to at least one subscriber, wherein the transmitted message has a first topic name within a sequence of topic names and is transmitted to subscribers that are subscribed to receive messages having the first topic name; receive an unsubscribe request from the first subscriber which unsubscribe request specifies the first topic name subsequent to transmitting a received message having the first topic name to a first subscriber; and update the subscription information maintained at the message broker such that the first subscriber is no longer subscribed to receive messages having the first topic name in response to receiving the unsubscribe request.

18. A data processing system for controlling publication of messages for publish/subscribe messaging, the system comprising:
a data processing unit;
a data storage unit; and
a publisher program configured to: assign sequential topic names to a sequence of messages and publishing the messages with their respective assigned topic name; check whether any subscribers are active for assigned topic names; and republish messages having topic names for which said checking determines that at least one subscriber is active, without republishing messages having topic names for which no subscribers are active.
